(19) United States
(12) Patent Application Publication
(10) Pub. No.: US 2023/0298408 A1
(43) Pub. Date: Sep. 21, 2023

(54) VEHICLE ROLLOVER NOTIFICATION SYSTEM

(71) Applicant: INNOVATIVE AFTERMARKET GROUP, Phoenix, AZ (US)

(72) Inventors: Carl Anthony (“Tony”) Avila, Phoenix, AZ (US); Andrew Ciccarelli, Tempe, AZ (US)

(21) Appl. No.: 18/186,576

(22) Filed: Mar. 20, 2023

Related U.S. Application Data
(60) Provisional application No. 63/269,677, filed on Mar. 21, 2022.

(51) Int. Cl. G07C 5/00; G06V 20/56

(52) U.S. Cl. CPC G07C 5/008; G06V 20/56

(57) ABSTRACT

A system for tracking a rollover or flip of a vehicle includes a tracker unit and a camera on the vehicle. The tracker unit has an accelerometer and a processor and can communicate with the camera. The tracker unit uses data output from the accelerometer to determine whether the vehicle has rolled over or flipped. When the tracker unit processor determines that the vehicle has rolled over, it causes the camera to capture an image and sends a notice of the rollover or flip to a server.

### RELATED APPLICATIONS

This application claims benefit of, and incorporates by this reference the entirety of, U.S. provisional patent application Ser. No. 63/269,677, filed Mar. 21, 2022, entitled VEHICLE ROLLOVER NOTIFICATION SYSTEM.

### BACKGROUND

This invention relates generally to accident detection and notification systems for recreational vehicles. More particularly, it relates to a system that can track the orientation of a recreational vehicle, can sense whether the vehicle has flipped or rolled over, and can send a notice of such an event to a user of the system.

It is an object of the present invention to provide such a system. Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a system for tracking a rollover or flip of a vehicle, such as a motor bike, powersport vehicle, or other recreational vehicle. The system includes a tracker unit and a camera configured for installation on the vehicle. The tracker unit has an accelerometer and a processor and is configured to communicate wirelessly with the camera. The tracker unit is configured to use data output from the accelerometer to determine whether the vehicle has rolled over and is further configured so that, when the tracker unit processor determines that the vehicle has rolled over, it causes the camera to capture an image and send a notice of the rollover to a server.

In one advantageous embodiment, the tracker unit is configured to calculate a plurality of orientation values over a preset period of time based on the data output from the accelerometer and to determine that the vehicle has rolled over if the plurality of orientation values reflects a change in the orientation values greater than a preset threshold amount.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a block diagram of the components of one embodiment of a tracking system for detecting and providing notice of a rollover or flip of a vehicle in accordance with the present invention.

FIG. 2 is a flow chart depicting the operation of the system of FIG. 1.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition. Also, the terms “rollover” and “flip” are sometimes used interchangeably in this document. For example, the term “rollover” as used in the claims includes a “flip.”

In accordance with one advantageous aspect of the invention, the tracker unit does not have to be installed in a specific, predefined orientation, and does not have to be calibrated to such a predefined orientation to operate. The tracker unit not only considers the acceleration values but also the rapid change in orientation values to recognize the rolling-over motion of a vehicle. Consequently, the tracker unit does not require that it be calibrated to a standard stationary orientation to operate. This benefit, along with its modular design, provides ease of installation.

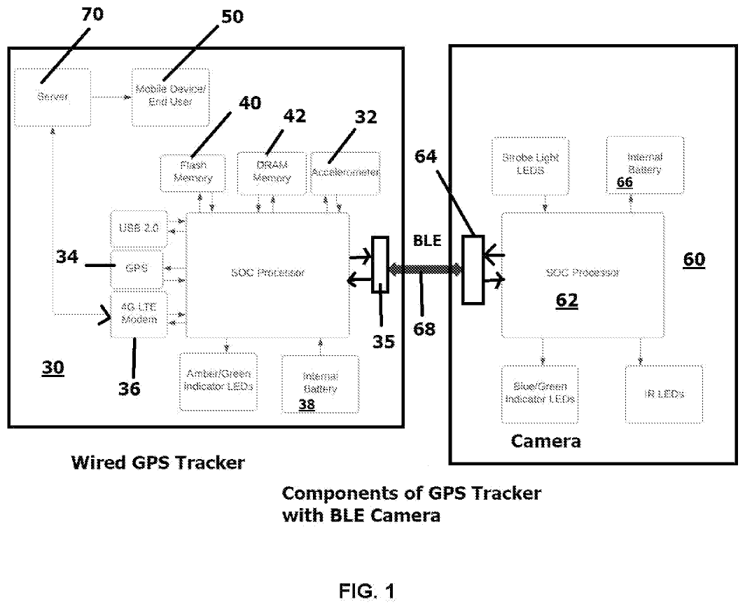

Referring to FIG. 1, a presently preferred embodiment of a system for tracking and providing notice of a vehicle flip or rollover according to the present invention includes a tracker unit 30 and a camera 60 that are onboard the vehicle (not shown). In one presently preferred embodiment, the tracker unit 30 is a modular unit equipped with a GPS device 34, an accelerometer 32, a cellular modem 36, a power supply 38 such as a rechargeable internal battery, and a processor 33. It will be understood by those of skill in the art that the tracker unit processor 33 can include one or more processor units or devices that together are suitable to perform the functions of the tracker unit 30. The tracker unit 30 can communicate wirelessly with the onboard camera 60, which also has a processor 62 and a power supply 66 that can include an internal, rechargeable battery. In a presently preferred embodiment, each of the tracker unit 30 and onboard camera 60 utilizes a wireless communication device 35, 64 to wirelessly connect to each other and transmit data through a communication connection 68, such as via a Bluetooth connection. The tracker unit processor 33 and tracker unit wireless communication device 35 can be part of a system on a chip (SoC), and the camera processor 62 and camera wireless communication device 64 also can be part of a SoC. Also, the tracker unit 30 can communicate via the cellular modem 36 with a server 70, which can communicate with a user mobile device 50.

In some embodiments, the processor 33 can be implemented using a microcontroller such as the MSP430F51x2 microcontroller marketed by Texas Instruments. In some embodiments, the accelerometer 32 can be implemented using a digital accelerometer, such as the MMA8453Q digital accelerometer marketed by Freescale Semiconductor, Inc.

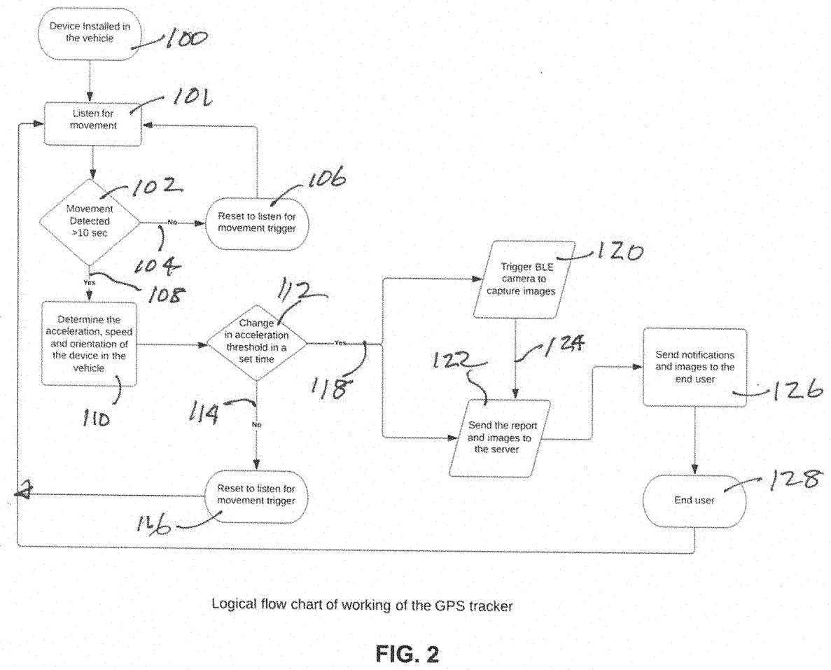

FIG. 2 shows one illustrative process by which the system of FIG. 1 can be used to track a rollover or flip of a vehicle. Referring to FIG. 2, after the tracker unit 30 is installed in a vehicle (step 100), the tracker unit processor 33 monitors whether there is movement of the vehicle using the output readings of the accelerometer 32 (step 101). The processor 33 can use the output readings of the accelerometer 32 to calculate the acceleration, speed, and change in orientation of the tracker unit 30 in the vehicle. If vehicle movement is not detected for more than a preselected time period (e.g., 10 seconds) (steps 102, 104), the process returns to step 101 (step 106) and the processor continues monitoring for vehicle movement. Referring again to step 102, if vehicle movement is detected for more than the preselected time period (e.g., 10 seconds) (step 108), the processor 33 then uses the output readings of the accelerometer 32 to calculate any change in orientation of the tracker unit 30 in the vehicle (step 110), which process includes checking the acceleration readings in three axes. The processor 33 then determines whether the calculated change in orientation of the tracker unit 30 is greater than a preset threshold amount within a preset time period (step 112) to determine whether the vehicle has flipped or rolled over. If the calculated orientation change does not exceed this preset threshold amount within the preset time period (step 114), the process returns to step 101 (step 116) and the processor continues monitoring for vehicle movement.

Referring again to step 112, if the calculated orientation change exceeds the preset threshold amount within the preset time period (step 118), the tracker unit 30 can send to the server 70 an appropriate notification report of this orientation change as a rollover or flip event (step 122) via the cellular mode 36. Also, the tracker unit 30 can trigger the onboard camera 12 via the communications connection 68 to cause the camera 12 to capture images (such as still pictures or a video) (step 120). The camera 12 can send the captured images via the communications connection 68 to the tracker unit 30 (step 124), which can include the images with the notification report sent to the server (step 122). The server 70 can then send the notification report of the rollover or flip event to the user mobile device (steps 126,128). After the processor sends the notification report, it can return to step 101 to continue monitoring for vehicle movement for future rollovers (in the event, for example, that after the rollover the vehicle is returned to an upright position or that the notification of the rollover turns out to be a false notification).

From the foregoing, it will be understood by those of skill in the art that the present invention provides a system and method for tracking the orientation of a vehicle, such as a motor bike, powersport vehicle, or other recreational vehicle. The system can sense whether the vehicle has flipped or rolled over and send a notice of such an event to a user of the system.

Upon reading this disclosure, additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

What is claimed is:

1. A system for tracking a rollover of a recreational vehicle, the system comprising:
a tracker configured for installation on a vehicle and including an accelerometer and a processor; and
a camera configured for installation on the vehicle;
wherein the tracker is configured to communicate with the camera;
wherein the tracker is configured to use data output from the accelerometer to determine whether the vehicle has rolled over; and
wherein the tracker is configured so that, when it determines that the vehicle has rolled over, the tracker causes the camera to capture an image and send a notice of the rollover to a server.

2. The system of claim 1 wherein the tracker is configured to calculate a plurality of orientation values over a preset period of time based on the data output from the accelerometer and to determine that the vehicle has rolled over if the plurality of orientation values reflect a change in the orientation values greater than a preset threshold amount.

3. The system of claim 1 wherein the tracker is configured to communicate wirelessly with the camera to cause the camera to capture the image.

4. The system of claim 1 wherein the tracker is powered by a rechargeable battery.

5. The system of claim 1 wherein the camera is powered by a rechargeable battery.

6. A method for tracking a rollover of a recreational vehicle, the method comprising:
providing a tracker configured for installation on a vehicle and including an accelerometer and a processor; and
with the tracker:
using data output from the accelerometer to determine whether the vehicle has rolled over; and
if the tracker determines that the vehicle has rolled over, generating a trigger signal to send a notice of the rollover to a server.

7. The method of claim 6 further comprising, in response to the trigger signal, capturing an image with a camera installed on the vehicle.

8. The method of claim 7 further comprising causing the tracker to send the captured image to the server.

9. The method of claim 7 wherein the step of capturing an image comprises capturing a still image or a video.

10. The method of claim 6 wherein the tracker calculates a plurality of orientation values over a preset period of time based on the data output from the accelerometer and determines that the vehicle has rolled over if the plurality of orientation values reflect a change in the orientation values greater than a preset threshold amount.
